(19) United States
(12) Patent Application Publication
(10) Pub. No.: US 2017/0212387 A1
(43) Pub. Date: Jul. 27, 2017

(54) DISPLAY APPARATUS AND DISPLAY PANEL HAVING LIQUID CRYSTAL CAPSULE LAYER

(71) Applicant: Samsung Electronics Co., Ltd., Suwon-si (KR)

(72) Inventors: Ki Hyung KANG, Suwon-si (KR); Jeong Ho LEE, Suwon-si (KR); Won Yong LEE, Suwon-si (KR)

(73) Assignee: Samsung Electronics Co., Ltd., Suwon-si (KR)

(21) Appl. No.: 15/353,266

(22) Filed: Nov. 16, 2016

(30) Foreign Application Priority Data
Jan. 25, 2016 (KR) 10-2016-0008670

(51) Int. Cl. G02F 1/13363; G02F 1/1334; G02F 1/1335

(52) U.S. Cl. CPC G02F 1/133634; G02F 1/133528; G02F 1/1334; G02F 2201/50; G02F 2001/133562

(57) ABSTRACT

A display apparatus and display panel having liquid crystal capsule layer on which a plurality of liquid crystal capsules are distributed; and an optical compensator configured to compensate an anisotropic refraction of the liquid crystal capsule layer.

### CROSS-REFERENCE TO RELATED APPLICATIONS

This application claims the benefit of Korean Patent Application No. 2016-0008670, field on Jan. 25, 2016 in the Korean Intellectual Property Office, the disclosure of which is incorporated herein by reference.

### BACKGROUND

1. Field

Embodiments of the present disclosure relate to a display panel and a display apparatus having the same, more particularly, to a display apparatus having a liquid crystal capsule layer.

2. Description of the Related Art

A display apparatus is a kind of output apparatus configured to convert information in the form of electrical signal into visual information to display the visual information.

For example, the display apparatus may be used in a personal computer, a server computer, a portable computer, a navigation system, a television, a smart phone, a tablet PC, a mobile device, a large display apparatus for industry/education/exhibition.

The display apparatus may display a stationary image or a moving image to a user by using a variety of display means. The display means may include Cathode Ray Tube (CRT), Light Emitting Diode (LED), Organic Light Emitting Diode (OLED), Active-Matrix Organic Light Emitting Diode, Liquid Crystal, or electronic paper. Among those, the most popular display means is Liquid Crystal Display (LCD).

### SUMMARY

Additional aspects and/or advantages will be set forth in part in the description which follows and, in part, will be apparent from the description, or may be learned by practice of the embodiments.

Therefore, it is an aspect of the present disclosure to provide a display apparatus capable of compensating a variation of optical properties of a liquid crystal capsule layer caused by a deformation of a plurality of liquid crystal capsules distributed in the liquid crystal capsule layer.

Additional aspects of the present disclosure will be set forth in part in the description which follows and, in part, will be obvious from the description, or may be learned by practice of the present disclosure.

In accordance with one aspect of the present disclosure, display apparatus comprising: a liquid crystal capsule layer on which a plurality of liquid crystal capsules is distributed; and an optical compensator configured to compensate an anisotropic refraction of the liquid crystal capsule layer.

In the display apparatus, wherein the anisotropic refraction of the liquid crystal capsule layer is caused by a deformation of the plurality of liquid crystal capsules.

In the display apparatus, wherein the deformation of the plurality of liquid crystal capsules is being deformed into an ellipsoid.

In the display apparatus, wherein the optical compensator is configured to have anisotropic optical properties to compensate the liquid crystal capsule layer so that a refractive index of the liquid crystal capsule layer in the horizontal direction is identical to a refractive index of the liquid crystal capsule layer in the vertical direction.

In the display apparatus, wherein when the refractive index in the horizontal direction is larger than the refractive index in the vertical direction with respect to an area of the liquid crystal capsule layer, a refractive index in a horizontal direction is smaller than a refractive index in a vertical direction with respect to an area of the optical compensator, and when the refractive index in the horizontal direction is smaller than the refractive index in the vertical direction with respect to the area of the liquid crystal capsule layer, the refractive index in the horizontal direction is larger than a refractive index in the vertical direction with respect to the area of the optical compensator.

The display apparatus may further include a first polarization unit and a protection unit disposed in a front side of the liquid crystal capsule layer, wherein the optical compensator is provided as a separate object between the first polarization unit and the protection unit.

The display apparatus may further include a first polarization unit and a protection unit disposed in a front side of the liquid crystal capsule layer, wherein the optical compensator is integrally formed with any one of the first polarization unit and the protection unit.

In the display apparatus, wherein the optical compensator is provided in any type of a film, a liquid crystal layer, or a thin film.

In accordance with another aspect of the present disclosure, display apparatus comprising: a liquid crystal capsule layer on which a plurality of liquid crystal capsules is distributed; a first polarization unit provided in a front side of the liquid crystal capsule layer; an optical compensator configured to compensate an anisotropic refraction caused by a deformation of the plurality of liquid crystal capsules in the liquid crystal capsule layer; a protection unit provided in a front side of the liquid crystal capsule layer to protect the liquid crystal capsule layer; and a second polarization unit provided in a rear side of the liquid crystal capsule layer.

In the display apparatus, wherein the deformation of the plurality of liquid crystal capsules is being deformed into an ellipsoid.

In the display apparatus, wherein the optical compensator is configured to have anisotropic optical properties to compensate the liquid crystal capsule layer so that a refractive index of the liquid crystal capsule layer in the horizontal direction is identical to a refractive index of the liquid crystal capsule layer in the vertical direction.

In the display apparatus, wherein when the refractive index in the horizontal direction is larger than the refractive index in the vertical direction with respect to an area of the liquid crystal capsule layer, a refractive index in a horizontal direction is smaller than a refractive index in a vertical direction with respect to an area of the optical compensator, and when the refractive index in the horizontal direction is smaller than the refractive index in the vertical direction with respect to the area of the liquid crystal capsule layer, the refractive index in the horizontal direction is larger than a refractive index in the vertical direction with respect to the area of the optical compensator.

In the display apparatus, wherein the optical compensator is provided as a separate object between the first polarization unit and the protection unit.

The display apparatus may further include a first polarization unit and a protection unit disposed in a front side of the liquid crystal capsule layer, wherein the optical compensator is integrally formed with any one of the first polarization unit and the protection unit.

In the display apparatus, wherein the optical compensator is provided in any type of a film, a liquid crystal layer, or a thin film.

In accordance with another aspect of the present disclosure, a display panel comprising: a liquid crystal capsule layer on which a plurality of liquid crystal capsules is distributed; and an optical compensator configured to compensate an anisotropic refraction of the liquid crystal capsule layer.

In accordance with another aspect of the present disclosure, a display panel comprising: a liquid crystal capsule layer on which a plurality of liquid crystal capsules is distributed; a first polarization unit provided in a front side of the liquid crystal capsule layer; an optical compensator configured to compensate an anisotropic refraction caused by a deformation of the plurality of liquid crystal capsules in the liquid crystal capsule layer; a protection unit provided in a front side of the liquid crystal capsule layer; and a second polarization unit provided in a rear side of the liquid crystal capsule layer.

In accordance with another aspect of the present disclosure, a display apparatus comprising: a liquid crystal capsule layer on which a plurality of liquid crystal capsules is distributed; and a first polarization unit integrally formed with an optical compensator configured to compensate an anisotropic refraction of the liquid crystal capsule layer.

In accordance with another aspect of the present disclosure, a display apparatus comprising: a liquid crystal capsule layer on which a plurality of liquid crystal capsules is distributed; and a protection unit integrally formed with an optical compensator configured to compensate an anisotropic refraction of the liquid crystal capsule layer.

In accordance with another aspect of the present disclosure a display apparatus, comprising: a light source polarization layer receiving light from a light source and having a first polarization; a substrate over the source polarization layer; a color converter over the substrate; a liquid crystal capsule layer over the color converter with the capsule layer causing an anisotropic refraction due to a ellipsoidal deformation of liquid crystal capsules and having a first refractive index; a liquid crystal capsule protection layer over the liquid crystal capsule layer; a viewing angle compensation film over the protection layer compensating for the anisotropic refraction and having a second refractive index different from the first refractive index; and a projection polarization film over the compensation film emitting light to a user and having a second polarization different from the first polarization.

### BRIEF DESCRIPTION OF THE DRAWINGS

These and/or other aspects of the present disclosure will become apparent and more readily appreciated from the following description of the embodiments, taken in conjunction with the accompanying drawings of which:

FIG. 1 is a view illustrating an exterior of a display apparatus in accordance with one embodiment of the present disclosure.

FIG. 2 is a block diagram illustrating a configuration of the display apparatus of FIG. 1.

FIG. 3 is an exploded-perspective view illustrating the display apparatus of FIG. 1.

FIG. 4 is a side cross-sectional view illustrating the display apparatus of FIG. 1.

FIG. 5 is a side cross-sectional view illustrating the display panel of the display apparatus in accordance with one embodiment of the present disclosure.

FIG. 6 is a view illustrating a liquid crystal capsule of the display panel in accordance with one embodiment of the present disclosure.

FIG. 7 is a view illustrating an electric field formed on the liquid crystal capsule layer when the power is applied to the display panel of the display apparatus in accordance with one embodiment of the present disclosure

FIG. 8 is a view illustrating an optical path in the display panel of the display apparatus in accordance with one embodiment of the present disclosure.

FIG. 9 is a view illustrating a deformation of the liquid crystal capsule in the display panel.

FIG. 10 is a view illustrating a variation of optical properties of the liquid crystal capsule layer according to the deformation of the liquid crystal capsule.

FIG. 11 is a view illustrating an operation of the viewing angle compensation film of the display panel in accordance with one embodiment.

FIG. 12 is a view illustrating an operation of a viewing angle compensation film of a display apparatus in accordance with another embodiment.

FIG. 13 is a view illustrating an operation of a viewing angle compensation film of a display apparatus in accordance with another embodiment.

### DETAILED DESCRIPTION

Reference will now be made in detail to the embodiments, examples of which are illustrated in the accompanying drawings, wherein like reference numerals refer to the like elements throughout. The embodiments are described below by referring to the figures.

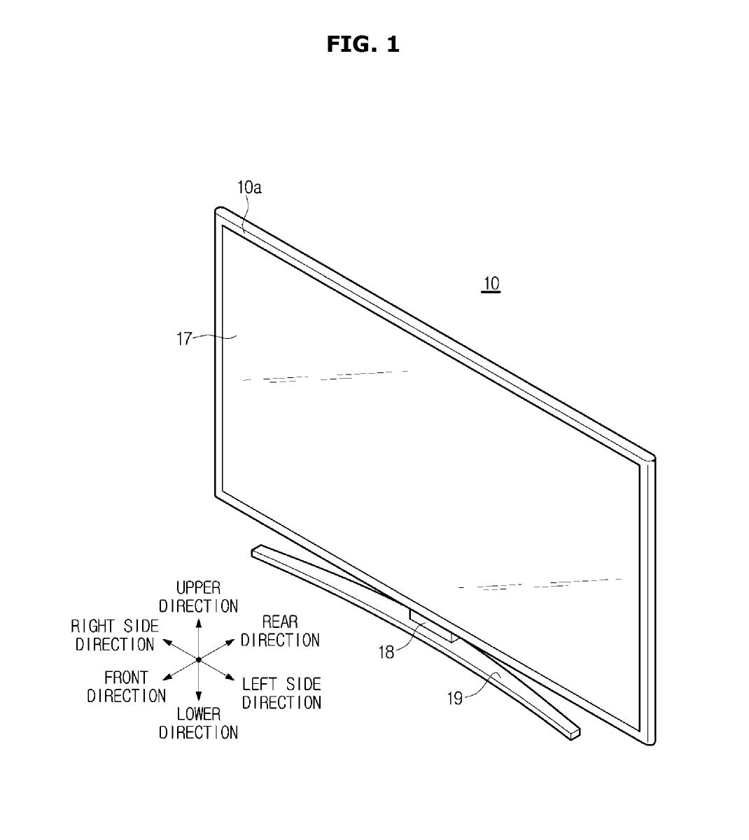

FIG. 1 is a view illustrating an exterior of a display apparatus in accordance with one embodiment of the present disclosure. As illustrated in FIG. 1, a display apparatus 10 may include an exterior housing 10a, an image display unit 17, a support 18 and a leg 19.

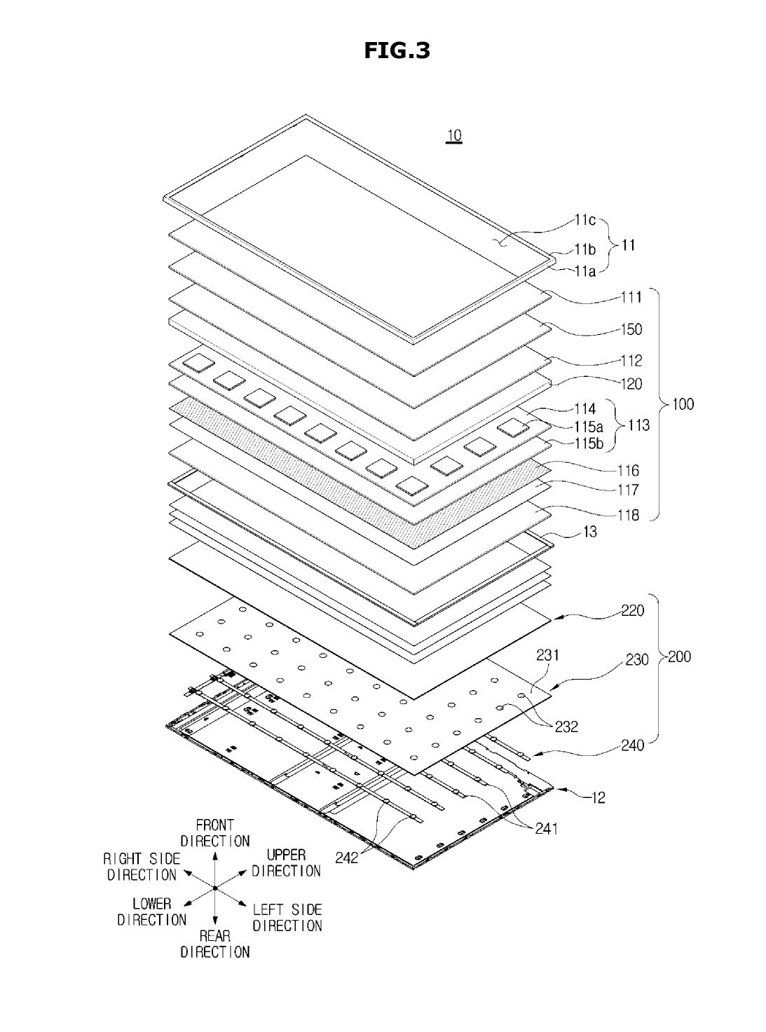

The exterior housing 10a may form an exterior of the display apparatus 10. A variety of components configured to allow the display apparatus 10 to display an image may be placed in the inside of the exterior housing 10a. The exterior housing 10a may be formed by combining with a front housing 11 (refer to FIG. 3) and a rear housing 12 (refer to FIG. 3). In addition to the exterior housing 10a, a middle housing 13 (refer to 3) may be further provided.

The image display unit 17 may be installed in a front direction of the exterior housing 10a to display a variety of images. The image display unit 17 may display at least one of a stationary image or a moving image. The image display unit 17 may be implemented using a display panel 100, but is not limited thereto. According to embodiments, a touch screen panel may be additionally provided in the front of the display panel 100.

The support 18 may support the exterior housing 10a while connecting the exterior housing 10a to the leg 19. The support 18 may be formed in various shapes. In addition, the support 18 may be omitted, or the support 18 may have a shape to be attached or detached to or from the exterior housing 10a.

The leg 19 may be connected to the support 18, and allow the display apparatus 10 to be stably stand on the ground. The leg 19 may be coupled to or separated from the support 18. The leg 19 may be directly connected to the exterior housing 10a. In addition, the leg 19 may be omitted.

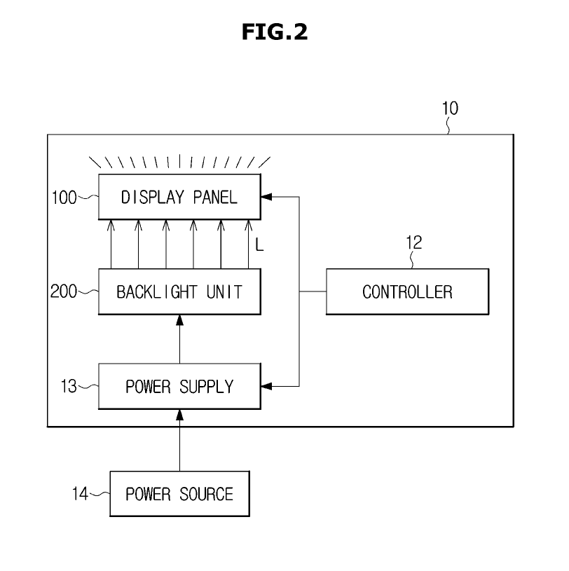

FIG. 2 is a block diagram illustrating a configuration of the display apparatus of FIG. 1. As illustrated in FIG. 2, according to one embodiment, the display apparatus 10 may include a controller 129; a power supply 13; a display panel 100; and a back light unit (BLU) 200.

The display panel 100 may generate an image by transmitting or blocking an incident light (L) and display the image. One surface of the display panel 100 may receive a light (L) provided from the backlight unit 200, and after a plurality of pixels of the display panel 100 performs a light conversion to generate an image, the display panel 100 may output the light (L) to the outside through the other surface, wherein the other surface corresponds to a rear surface of the one surface in which a light (L) is received. The display panel 100 may be formed by a plurality of pixels, and the plurality of pixels may be formed with a pre-determined number of sub-pixels. For example, three sub-pixels configured to display red (R), green (G), and blue (B) may form a single pixel. That is, “Pixel” is a basic unit for the function of the display apparatus, and “Sub-pixel” is a smaller unit to form each pixel. A light in a certain color may be displayed on a single pixel of the display panel such that light (L) corresponding to each of sub-pixel is mixed to each other. Further, the display panel may generate an image by combining the light emitted from each pixel, and display the image.

The backlight unit 200 may generate and diffuse the light (L) to emit the light (L) to the display panel 100 so that the light (L) is incident to an entire region of one surface of the display panel 100. The backlight unit 200 may generate a white color light or a blue color light and allow the white color light or the blue color light to be incident to one surface of the display panel 100. The display panel 100 may convert a color using a color converter 116 (refer to FIG. 3) e.g. a color filter, and then emit the light having converted color. The backlight unit 200 may be formed in a direct-lit manner and an edge-lit manner.

The controller 129 may allow the display panel 100 to perform a required operation by controlling an entire operation of the display apparatus 10. For example, the controller 129 may allow the display apparatus 10 to display a certain stationary image or moving image by controlling the power supply 13 or the display panel 100. The controller 129 may include at least one processor, wherein the processor may be implemented using one or more semiconductor chip and a variety of component for the operation of the semiconductor chip. Meanwhile, the display apparatus 10 may further include a storage (not shown) to store a variety of data to support an operation of the processor. The storage may be implemented by a semiconductor storage device, e.g. ROM/RAM or a solid state drive (SSD), or a magnetic disk storage device, e.g. hard disk drive (HDD).

The power supply 13 may supply the power to the display panel 100 to the backlight unit 200 for the output of the image. The power supply 13 may be connected to a commercial power source 14. The power supply 13 may convert AC power supplied from the commercial power source 14 into DC power needed for the operation of the display apparatus 10, or into AC power having a different frequency/phase. The power supply 13 may include a battery to store the electric power. The battery may be rechargeable.

The display apparatus 10 may include a variety of devices configured to display a stationary image or a moving image, e.g. a television receiver, a variety of audio/video system, a home theater system, a desktop computer, a computer monitor, a camera, a moving image capture device, an electronic advertising board, or a portable terminal, wherein the portable terminal may include a notebook computer, a cellular phone, a smart phone, a tablet PC, an electronic book terminal, a PDA, a navigation terminal, or a portable game player. However, the display apparatus 10 is not limited thereto, and thus a variety of devices configured to display a stationary image or a moving image and used in the indoor and the industrial field, may be employed as the display apparatus.

Hereinafter a television will be described as an example of the display apparatus 10. But the display apparatus 10 is not limited to the television, and as mentioned above, the display apparatus 10 may be implemented by a variety of devices.

Hereinafter for convenience of description, as for the display apparatus 10, a direction in which an image is displayed may be defined as a front direction, and a direction opposite to the front direction with respect to the display apparatus 10 may be defined as a rear direction. A direction in which the support 18 (refer to FIG. 1) of the display apparatus 10 is formed may be defined as a lower direction, and a direction opposite to the lower direction may be defined as an upper direction. When the front direction is a 12 o'clock direction with respect to the upper direction, a right direction may be a 3 o'clock direction and a left direction may be a 9 o'clock direction. Therefore, the upper direction of FIG. 3 may be the front direction of the display apparatus 10, and the lower direction of FIG. 3 may be the rear direction of the display apparatus 10. The definition will be applied to other drawings. The definition of the direction is merely for convenience of the description, and the direction may be differently defined by the designer.

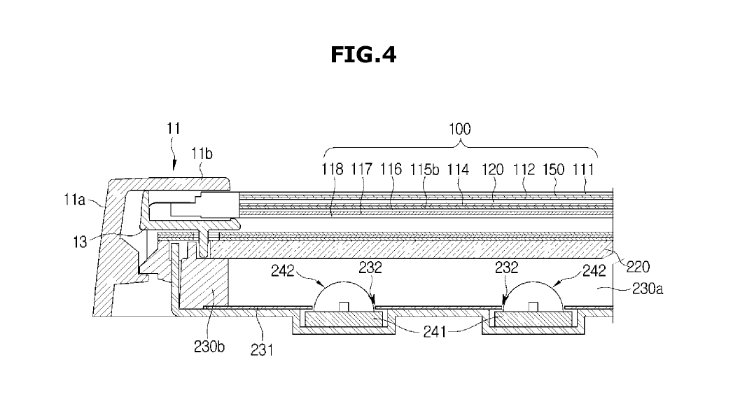

FIG. 3 is an exploded-perspective view illustrating the display apparatus of FIG. 1, and FIG. 4 is a side cross-sectional view illustrating the display apparatus of FIG. 1. A configuration of the display apparatus 10 will be described in detail with reference to FIGS. 3 and 4. As illustrated in FIGS. 3 and 4, the display apparatus 10 may include a housing 11 and 12 forming an exterior of the display apparatus 10, the display panel 100 generating an image, and the backlight unit 200 supplying a light to the panel.

The housing 11 and 12 may include a front housing 11 installed in a front direction and a rear housing 12 installed in a rear direction. The front housing 11 and the rear housing 12 may be integrally formed or may be separately formed and then coupled to each other.

The front housing 11 may be placed in the most front direction of the display apparatus 10, and may form a front surface and/or a part of side surface of the display apparatus 10. The front housing 11 may be coupled to the rear housing 12 so that a variety of components of the display apparatus 10 may be embedded in the display apparatus 10. The front housing 11 may stably fix the various components embedded in the display apparatus 10, e.g. the display panel 100, while protecting the various components from an impact directly delivered from the outside.

In the front surface of the front housing 11, an opening 11c may be formed. The opening 11c may expose the display panel 100 to the outside to allow an image generated by the display panel 100 to be displayed so that a user may watch the image. An image, which is formed of a light passing through a first polarization unit 111, may be exposed to the outside via the opening 11c.

The rear housing 12 may be placed in the most rear direction of the display apparatus 10 and form a rear surface and/or a part of a side surface of the display apparatus 10. The rear housing 12 may be coupled to the front housing 11 so that a variety of components of the display apparatus 10 may be embedded in the display apparatus 10. On an internal wall of the rear housing 12, a reflection plate 230 and a light emitter 240 of the backlight unit 200 may be installed.

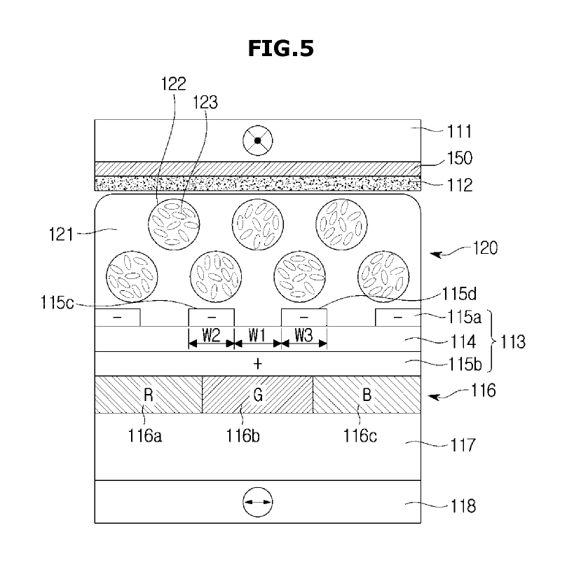

FIG. 5 is a side cross-sectional view illustrating the display panel of the display apparatus in accordance with one embodiment of the present disclosure. Although a reference numeral is given to some components in FIGS. 3 and 4, some components have not been described and thus a description thereof will be described with reference to FIG. 5.

As illustrated in FIG. 5, the display panel 100 of the display apparatus 10 may include a first polarization unit 111; a viewing angle compensation film 150; a liquid crystal capsule layer protection unit 112; a liquid crystal capsule layer 120; an electrode layer 113; a color converter 116; a substrate 117 and a second polarization unit 118. The viewing angle compensation film 150 may correspond to an optical compensator to reverse or compensate an isotropic refraction by compensating an anisotropic refraction of the liquid crystal capsule layer 120. The liquid crystal capsule layer protection unit 112 may correspond to a protector to protect the liquid crystal capsule layer 120.

The first polarization unit 111 may be installed in the most front surface of the display panel 100 to polarize an incident light so as to emit the polarized light. One surface of the first polarization unit 111 may be exposed to the outside via the opening 11c, and the other surface of the first polarization unit 111 may make contact with the liquid crystal capsule layer protection unit 112 or the liquid crystal capsule layer 120. The first polarization unit 111 may be implemented in a film type.

A light passing through the liquid crystal capsule layer protection unit 112 or a light penetrating the liquid crystal capsule layer 120 may be incident to the other surface of the first polarization unit 111. The light delivered by passing through the liquid crystal capsule layer protection unit 112 or the light penetrating the liquid crystal capsule layer 120 may penetrate the second polarization unit 118 described later, and then polarized in a vertical direction or a horizontal direction. As mentioned above, the light polarized in the vertical direction or the horizontal direction via the second polarization unit 118 may be emitted to the outside by passing through the first polarization unit 111 in a vibration direction or blocked by the first polarization unit 111.

The first polarization unit 111 may include a vertical polarization filter in which a polarization axis is the vertical direction and a horizontal polarization filter in which a polarization axis is the horizontal direction. The polarization axis of the first polarization unit 111 may be different from the polarization axis of the second polarization unit 118. Particularly, the polarization axis of the first polarization unit 111 may be perpendicular to the polarization axis of the second polarization unit 118. Therefore, when the second polarization unit 118 is the vertical polarization filter, the first polarization unit 111 may be the horizontal polarization filter, and when the second polarization unit 118 is the horizontal polarization filter, the first polarization unit 111 may be the vertical polarization filter.

One surface of the liquid crystal capsule layer 120 in the front direction may face the first polarization unit 111. A plurality of liquid crystal capsules 122 may be provided in the liquid crystal capsule layer 120 and thus when a light is incident from a rear direction of the liquid crystal capsule layer 120, the liquid crystal capsule layer 120 may induce the incident light to be double refracted according to an electric field applied to the liquid crystal capsules 122.

According to one embodiment, the liquid crystal capsule layer 120 may include a polymer matrix 121 and a plurality of liquid crystal capsules 122 distributed in the polymer matrix 121. “Polymer matrix” may represent an organization made of a polymer that is a molecule having a relatively very large molecular weight. The Polymer matrix 121 may be implemented using a transparent material, e.g. a synthetic resin. In addition, the polymer matrix 121 may be formed of epoxy, polyurethane, methacrylate, dicyclopentadiene epoxy, polydicyclopentadiene or polyimide. The plurality of the liquid crystal capsules 122 may be randomly distributed in the polymer matrix 121.

The liquid crystal capsule layer protection unit 112 may be provided between the first polarization unit 111 and the liquid crystal capsule layer 120. The liquid crystal capsule layer protection unit 112 may provide a function of protecting the liquid crystal capsule layer 120. Particularly, when the liquid crystal capsule layer 120 makes contact with outside air, the life cycle of the material of the liquid crystal capsule layer 120 may be reduced due to the characteristics of organic material. Therefore, in order to prevent the reduction of the life cycle thereof, the liquid crystal capsule layer protection unit 112 may be installed one surface of the liquid crystal capsule layer 120 in the front direction to block a connection between the outside air and the liquid crystal capsule layer 120. In addition, the liquid crystal capsule layer protection unit 112 may play a role of maintaining an initiative status or shape of the liquid crystal capsule layer 120. For example, the liquid crystal capsule layer protection unit 112 may maintain an initiative status of a coating layer formed in an external surface of the liquid crystal capsule layer 120. The liquid crystal capsule layer protection unit 112 may be implemented using a certain protection film.

The liquid crystal capsule layer 120 may have the intensity and flexibility to independent exist, and thus an additional substrate may be not needed in the front direction that is a direction in which the first polarization unit 111 is placed. Accordingly, the manufacture process may be simple and a curved display panel or a flexible display panel may be realized.

On one surface of the liquid crystal capsule layer 120 in the rear direction, the electrode layer 113 forming an electric field on the liquid crystal capsule layer 120 may be provided. According to one embodiment, in the electrode layer 113, an electrode 115a and 115b may be structured in a Fringe-Field Switching (FFS) method. The electrode arrangement structure according to the Fringe-Field Switching (FFS) method may include an electrode arrangement structure according to a Plane-to-Line Switching (PLS) method or an electrode arrangement structure according to an Advanced Super Dimension Switching (ADS) method.

The electrode layer 113 may include an insulation substrate 114; a pixel electrode 115a; and a common electrode 115b.

The insulation substrate 114 may be provided such that the pixel electrode 115a is installed on one surface thereof in a direction of the liquid crystal capsule layer 120 and the common electrode 115b is installed on one surface thereof in the rear direction. In this case, the liquid crystal capsule layer 120 may be attached or evaporated to one surface of the insulation substrate 114 so that the liquid crystal capsule layer 120 may be formed on the insulation substrate 114. The insulation substrate 114 may provide a function of preventing a current from directly flowing between the pixel electrode 115a and the common electrode 115b. The insulation substrate 114 may be implemented using a transparency material so that a light passing through the second polarization unit 118 is penetrated. For example the insulation substrate 114 may be implemented using synthetic resins, e.g. acryl, or glass. The insulation substrate 114 may include a rigid substrate, a flexible substrate, or a rigid flexible substrate. “Rigid flexible substrate” may represent a multilayer substrate in which a flexible substrate and a rigid substrate are attached to each other.

The pixel electrode 115a may be opposite to the common electrode 115b with respect to the insulation substrate 114, and together with the common electrode 115b, the pixel electrode 115a may apply the current to the liquid crystal capsule layer 120. One surface of the pixel electrode 115a in the front direction may make contact with the liquid crystal capsule layer 120 or close to the liquid crystal capsule layer 120. The pixel electrode 115a may be cathode (−) or anode (+). The pixel electrode 115a may be implemented using Thin Film Transistor (TFT). The pixel electrode 115a may be supplied with the power by being connected to the external power source.

A plurality of pixel electrodes 115a, 115c, and 115d may be installed on the insulation substrate 114. According to one embodiment, the pixel electrodes 115a, 115c, and 115d may be arranged on the insulation substrate 114 in a certain pattern, and the arrangement pattern of the pixel electrodes 115a, 115c, and 115d may correspond to each pixel of the display panel 100. The arrangement pattern of the pixel electrodes 115a, 115c, and 115d may be determined according to a designer and thus may have a various patterns.

The plurality of pixel electrodes 115c and 115d may be apart from each other with a certain length w1. In this case, a width w2 and w3 of the each pixel electrode 115c and 115d may be larger than the distance w1 between the plurality of pixel electrodes 115c and 115d. The width w2 and w3 of the each pixel electrode 115c and 115d may represent a distance between a left side end and a right side end of the pixel electrode 115c and 115d, or a distance between an upper side end and a lower side end of the pixel electrode 115c and 115d. In other words, the size of the plurality of pixel electrodes 115c and 115d may be larger than the distance in which each of the pixel electrodes 115c and 115d are apart from each other.

Together with the pixel electrode 115a, the common electrode 115b may apply the current to the liquid crystal capsule layer 120 so that a liquid crystal molecule 123 inside of the liquid crystal capsule 122 in the liquid crystal capsule layer 120 is oriented. The common electrode 115b may have a polarity opposite to a polarity of the pixel electrode 115a. For example, when the pixel electrode 115a is cathode, the common electrode 115b may be anode, and when the pixel electrode 115a is anode, the common electrode 115b may be cathode. One surface of the common electrode 115b in the front direction may make contact with one surface of the insulation substrate 114 in the rear direction. According to one embodiment, one surface of the common electrode 115b in the rear direction may make contact with the color converter 116 or may be close to the color converter 116.

The viewing angle compensation film 150 may reveal or fix isotropic optical properties of the liquid crystal capsule layer 120 by compensating anisotropic optical properties of the liquid crystal capsule layer 120. The viewing angle compensation film 150 may be disposed between the liquid crystal capsule layer 120 and the first polarization unit 111. Particularly, the viewing angle compensation film 150 may be disposed between a front surface of the liquid crystal capsule layer protection unit 112 disposed between the liquid crystal capsule layer 120 and the first polarization unit 111, and a rear surface of the liquid crystal capsule layer 120. When the optical properties of the liquid crystal capsule layer 120 produce the anisotropic refraction, the viewing angle compensation film 150 may have optical properties of anisotropic refraction that is opposite to the anisotropic refraction of the liquid crystal capsule layer 120. Accordingly, the anisotropic refraction of the liquid crystal capsule layer 120 may be compensated by the anisotropic refraction of the viewing angle compensation film 150 that is opposite to that of the liquid crystal capsule layer 120, and thus optical properties of isotropic refraction may be compensated.

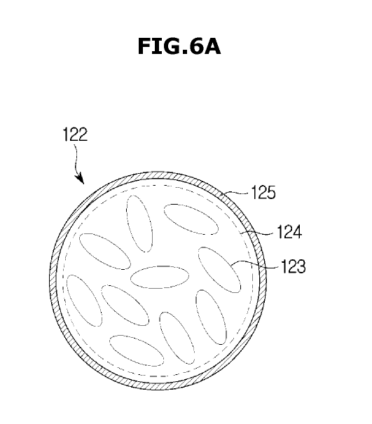

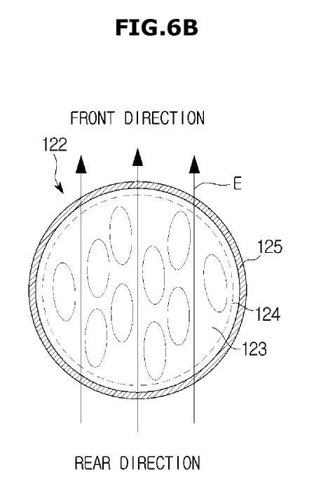

FIG. 6 is a view illustrating a liquid crystal capsule of the display panel in accordance with one embodiment of the present disclosure. FIG. 6A is a view of a structure of the liquid crystal capsule 122, and FIG. 6B is a view of a state in which an electric field is formed in the liquid crystal capsule 122.

As illustrated in FIG. 6A, an inside of the liquid crystal capsule 122 may be filled with a liquid crystal so that the liquid crystal molecule 123 is embedded therein. The liquid crystal capsule 122 may be formed in a nano size. For example, the liquid crystal capsule 122 may be a sphere or an ellipsoidal with a diameter of approximately 10 nm to 300 nm.

The liquid crystal capsule 122 may be manufactured using interfacial polymerization, complex coacervation, membrane emulsification method or in-situ polymerization method.

Particularly, the liquid crystal capsule 122 may include the liquid crystal molecule 123; a surfactant 124; and a capsule outer wall 125.

The liquid crystal molecule 123 may be distributed in the capsule outer wall 125 of the liquid crystal capsule 122. As illustrated in FIG. 6A, when an additional electric field (E) is not formed in the liquid crystal capsule 122, the liquid crystal molecule 123 may be randomly arranged inside of the capsule outer wall 125. In contrast, as illustrated in FIG. 6B, when an additional electric field (E) is formed in the liquid crystal capsule 122, the liquid crystal molecule 123 may be arranged in a single direction along a direction of the electric field (E).

The liquid crystal molecule 123 may include a positive liquid crystal molecule or a negative liquid crystal molecule. The positive liquid crystal molecule is a liquid crystal molecule arranged in a horizontal direction with respect to the direction of the electric field (E), and the negative liquid crystal molecule is a liquid crystal molecule arranged in a vertical direction with respect to the direction of the electric field (E). For example, in a state in which the liquid crystal molecule 123 is the positive liquid crystal molecule, when the electric field (E) is formed from the rear side to the front side, the liquid crystal molecule 123 may be arranged in a single direction along a direction of the electric field (E), as illustrated in FIG. 6B.

The surfactant 124 may be distributed inside of the capsule outer wall 125 of the liquid crystal capsule 122. The surfactant 124 may allow the liquid crystal molecule 123 to be free to move or change a direction with a certain degree in the capsule outer wall 125 by changing an interaction force between the liquid crystal molecule 123 and the capsule outer wall 125. Accordingly, the liquid crystal molecule 123 inside of the liquid crystal capsule 122 may be relatively easily oriented. The surfactant 124 may be injected into the liquid crystal capsule 122 as additives. When the surfactant 124 is injected into the inside of the liquid crystal capsule 122, the surfactant 124 may be mainly distributed on an internal surface of the capsule outer wall 125, thereby changing the interaction force between the liquid crystal molecule 123 and the capsule outer wall 125, as illustrated in FIGS. 6A and 6B. According to embodiments, the surfactant 124 may be omitted.

The capsule outer wall 125 may include the liquid crystal molecule 123 inside thereof, and according to embodiments, the capsule outer wall 125 may further include the surfactant 124 inside thereof. The capsule outer wall 125 may protect the plurality of the liquid crystal molecule 123 from the inside. In addition, the capsule outer wall 125 may separate the plurality of the liquid crystal molecule 123 from the polymer matrix 121 to prevent the plurality of the liquid crystal molecule 123 from being distracted in the liquid crystal capsule layer 120 due to the deformation of the polymer matrix 121 caused by an external pressure. The capsule outer wall 125 may be manufactured using high-molecular-mass compound, e.g., polymer. According to one embodiment, dielectric constant (ac) of the liquid crystal molecule 123 may be equal to or more than a value of 10.

Hereinafter, an electric field formed in the liquid crystal capsule layer 120 when the power is applied to both electrodes 115a and 115b of the display panel 100, and an optical path according to the generated electric field will be described.

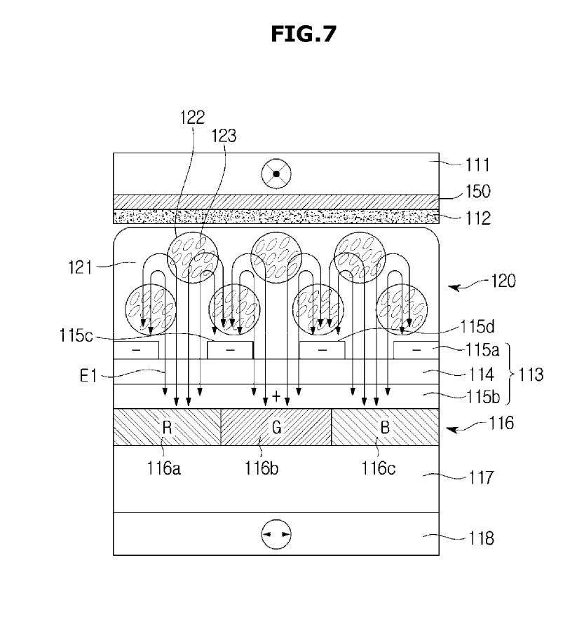

FIG. 7 is a view illustrating an electric field formed on the liquid crystal capsule layer when the power is applied to the display panel of the display apparatus in accordance with one embodiment of the present disclosure.

When the power is applied to the pixel electrode 115a and the common electrode 115b of the electrode layer 113, a fringe field (E1) may be formed between the pixel electrode 115a and the common electrode 115b, as illustrated in FIG. 7. The fringe field (E1) may represent an electric field moving from the outside to the inside of the liquid crystal capsule layer 120 on one surface of the liquid crystal capsule layer 120, and then after changing a direction thereof inside of the liquid crystal capsule layer 120, moving to the outside from the inside of the liquid crystal capsule layer 120 on the same surface of the liquid crystal capsule layer 120. When an electric field is formed inside of the liquid crystal capsule layer 120 by the fringe field (E1), an electric field in a certain direction (e.g. a lateral direction) may be applied to the liquid crystal molecule 123 inside of the liquid crystal capsule 122. As mentioned above, when the electric field in the certain direction is applied to the liquid crystal molecule 123, the liquid crystal molecule 123 may be oriented in the certain direction, and according to the arrangement of the liquid crystal molecule 123 in the liquid crystal capsule layer 120, a light incident via the other surface of the rear side of the liquid crystal capsule layer 120 may be double refracted and then emitted to one surface of the front side of the liquid crystal capsule layer 120.

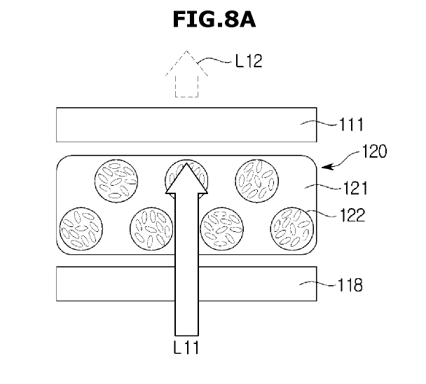

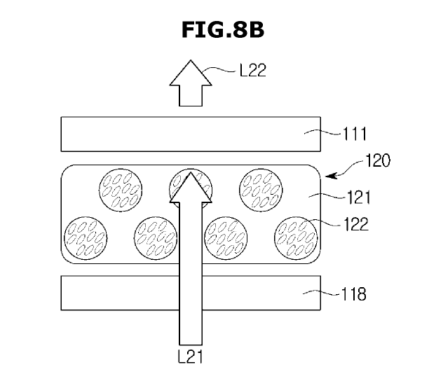

FIG. 8 is a view illustrating an optical path in the display panel of the display apparatus in accordance with one embodiment of the present disclosure. As illustrated in FIG. 8A, when the electric field (E1) is not formed in the liquid crystal capsule layer 120, the liquid crystal molecule 123 inside of the liquid crystal capsule 122 may be basically arranged to have a random directivity. In this case, a double refraction is not generated in the liquid crystal capsule layer 120, a light (L11) passing through the second polarization unit 118 and the liquid crystal capsule 122 may not pass through the first polarization unit 111 (L12). Therefore, the light may be not emitted to the outside via the first polarization unit 111, and the display panel 100 may be displayed in black color. However, the structural limitation of the first polarization unit 111 and the second polarization unit 118 may cause a minor light leakage.

In contrast, as illustrated in FIG. 8B, when the electric field (E1) is formed in the liquid crystal capsule layer 120, the liquid crystal molecule 123 may be oriented in the liquid crystal capsule 122. In this case, a light (L21) passing through the second polarization unit 118 and then incident to the liquid crystal capsule layer 120 may be emitted to the outside via the first polarization unit 111 by the double refraction of the liquid crystal capsule 122 (L22). Accordingly, when the electric field (E1) is formed in the liquid crystal capsule layer 120, the display panel 100 may output a light having a certain color (e.g. white/blue/green/red based light) to the outside and thus the display panel 100 may display a certain stationary image or a moving image in various colors.

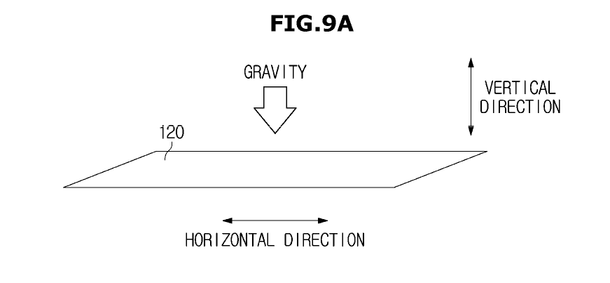

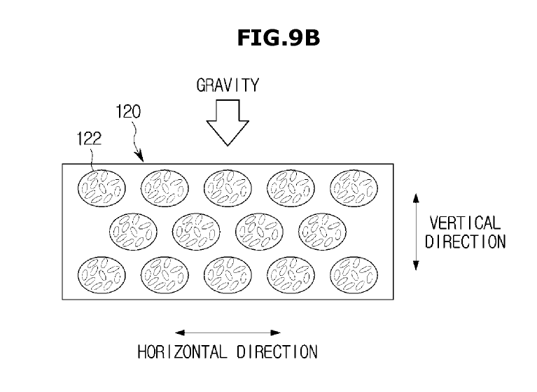

FIG. 9 is a view illustrating a deformation of the liquid crystal capsule in the display panel. Hereinafter a vertical direction and a horizontal direction may be defined as follows. Wth respect to the liquid crystal capsule layer 120 of FIG. 9, “vertical direction” may represent a normal direction (the front direction of FIG. 3) with respect to the surface (a wide surface) of the liquid crystal capsule layer 120, and “horizontal direction” may represent a parallel direction (the left-right direction of FIG. 3) with respect to the surface (a wide surface) of the liquid crystal capsule layer 120.

The manufacture process of the display panel 100 may include a drying and a hardening of the liquid crystal capsule layer 120. As for the liquid crystal capsule structure of the display panel 100, since the liquid crystal molecule 123 accommodated in each of the liquid crystal capsule 122 of the liquid crystal capsule layer 120 has a random directivity when the electric field is not applied, the liquid crystal molecule 123 may not transmit a light, but since the liquid crystal molecule 123 has a directivity to be arranged in the vertical direction when the electric field is applied, the liquid crystal molecule 123 may transmit a light. Therefore, when manufacturing the display panel 100, an alignment layer may be formed on the surface of the liquid crystal capsule layer 120 so that the liquid crystal molecule 123 accommodated in the liquid crystal capsule 122 has a random directivity although electric field is not applied. The formation of the alignment layer of the liquid crystal capsule layer 120 may include coating, drying, and hardening of an alignment liquid.

To coat the alignment liquid on the liquid crystal capsule layer 120, as illustrated in FIG. 9A, the liquid crystal capsule layer 120 may be disposed to allow the surface thereof to be perpendicular to a gravity direction (i.e. a wide surface faces an upper side). In a state in which the surface of the liquid crystal capsule layer 120 is perpendicular to the gravity direction, when applying the alignment liquid on the surface of the liquid crystal capsule layer 120, drying and hardening the applied alignment liquid, the formation of the alignment film of the liquid crystal capsule layer 120 may be completed.

The liquid crystal capsule 122 may be compressed by the gravity applied to the liquid crystal capsule layer 120 during the formation of the alignment film, and thus the liquid crystal capsule 122 may be deformed from a sphere to an ellipsoid. If the liquid crystal capsule 122 is initially formed in an ellipsoid, the liquid crystal capsule 122 may be changed to a more deformed ellipsoid due to the gravity. As for the liquid crystal capsule 122 deformed into the ellipsoid by the gravity, a length in the vertical direction may be relatively shorter and a length in the horizontal direction may be relatively longer. The deformed liquid crystal capsule 122 may be an elongated ellipsoid or a flattened ellipsoid.

As the liquid crystal capsule 122 is deformed from the sphere to the ellipsoid, a refractive index of the liquid crystal capsule layer 120 that is one of the optical properties may be changed. When the liquid crystal capsule 122 has a sphere shape, the liquid crystal capsule layer 120 may have the isotropic optical properties such that a refractive index (ny) of the liquid crystal capsule layer 120 in the vertical direction is identical to a refractive index (nx) of the liquid crystal capsule layer 120 in the horizontal direction. However, when the liquid crystal capsule 122 is deformed from the sphere shape to the ellipsoid shape, the liquid crystal capsule layer 120 may have the anisotropic optical properties due to the deformation of the liquid crystal capsule 122, such that the refractive index (nx) of the liquid crystal capsule layer 120 in the horizontal direction is larger than the refractive index (ny) of the liquid crystal capsule layer 120 in the vertical direction. Accordingly, when a user watches the display apparatus 10, there may be brightness differences between viewing the display apparatus 10 from the front side and diagonally viewing the display apparatus 10 from the lateral side. For example, when the display panel 100 is displayed in black color since the electric field is not applied to the liquid crystal capsule layer 120, a middle portion of the screen may be displayed in pure black color, but an edge portion of the screen may be displayed in relatively bright black since the light leakage caused by the anisotropic optical properties in the edge portion is relatively greater than in the middle portion. Those difficulties may lead to a difficulty in which a uniform color is not displayed although the electric field is applied to the liquid crystal capsule layer 120, due to the light leakage difference in between the middle portion and the edge portion.

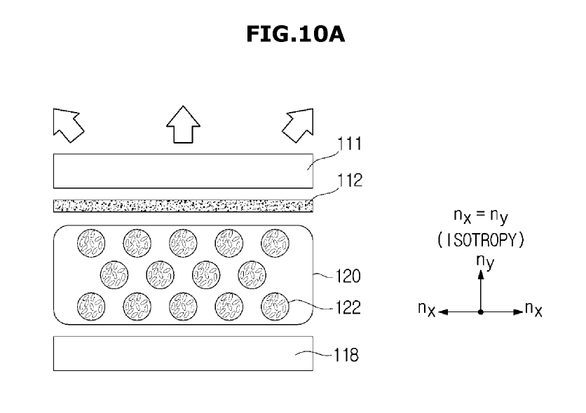

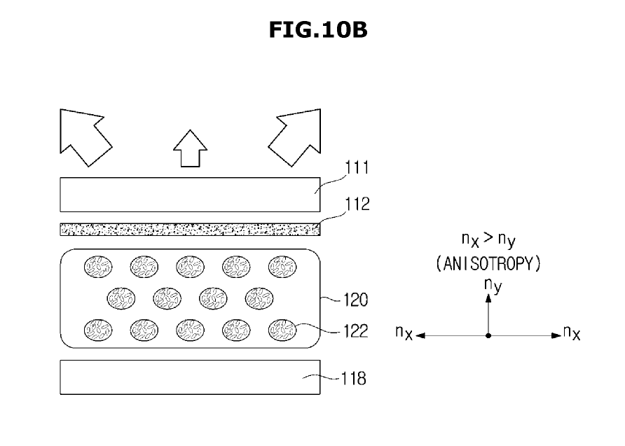

FIG. 10 is a view illustrating a variation of optical properties of the liquid crystal capsule layer according to the deformation of the liquid crystal capsule. FIG. 10 is illustrating that the viewing angle compensation film 150 according to one embodiment is not applied.

Since the liquid crystal molecule 123 of the liquid crystal capsule 122 has a random directivity when the electric field is not applied to the liquid crystal capsule layer 120, a light incident to the liquid crystal capsule layer 120 may not pass there through and thus a screen may be displayed in black color. When the electric field is not applied to the liquid crystal capsule layer 120, a light incident to the liquid crystal capsule layer 120 should be completely blocked. However, the light leakage may be unavoidable due to the structural limitation in the polarization unit of the conventional liquid crystal display panel. Even so, it may be needed to control the optical properties of the display panel 100 so that the light leakage is evenly distributed in all of viewing angle. The light leakage that is relatively greater in a certain viewing angle may limit a viewing angle of the display panel 100 and thus the color performance may be reduced.

The deformation of the liquid crystal capsule 122 from the sphere to the ellipsoid, as illustrated in FIG. 9, may cause that the refractive index (nx) of the liquid crystal capsule layer 120 in the horizontal direction is larger than the refractive index (ny) of the liquid crystal capsule layer 120 in the vertical direction. As illustrated in FIG. 10A, when the liquid crystal capsule 122 has a perfect sphere shape, the liquid crystal capsule layer 120 may have isotropic optical properties (nx=ny) and thus the liquid crystal capsule layer 120 may evenly transmit each light incident to the liquid crystal capsule layer 120 in all of viewing angles. However, when the liquid crystal capsule 122 is deformed into the ellipsoid, the liquid crystal capsule layer 120 may have anisotropic optical properties (nx>ny) and thus the light leakage in the horizontal direction (or diagonal direction) of the liquid crystal capsule layer 120 may be greater than the light leakage in the vertical direction of the liquid crystal capsule layer 120.

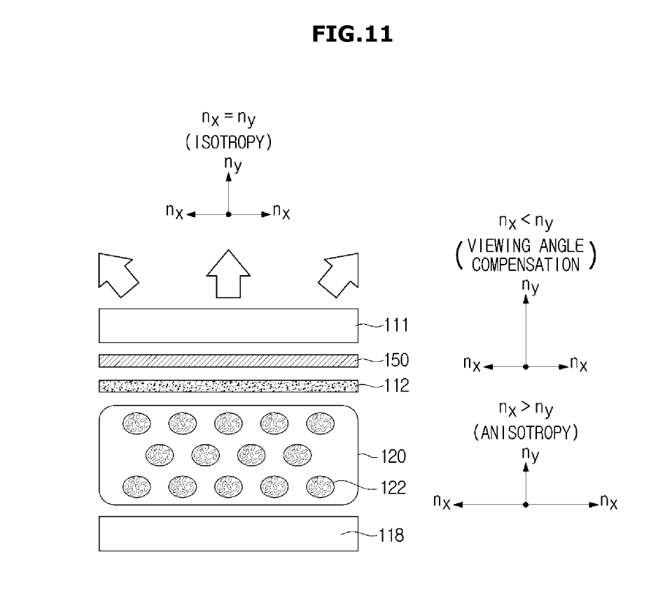

FIG. 11 is a view illustrating an operation of the viewing angle compensation film of the display panel in accordance with one embodiment. According to one embodiment, the viewing angle compensation film 150 may have optical properties (nx<ny), in which the refractive index (ny) in the vertical direction is larger than the refractive index (nx) in the horizontal direction, so that the isotropic optical properties (nx=ny) is revealed or fixed by compensating the anisotropic optical properties of the liquid crystal capsule layer 120 caused by the deformation of the liquid crystal capsule layer 120 to the ellipsoid. The anisotropic optical properties (nx<ny) of the viewing angle compensation film 150 may compensate the anisotropic optical properties (nx>ny) of the liquid crystal capsule layer 120 and thus the isotropic optical properties (nx=ny) may be revealed on the display panel 100, as illustrated in FIG. 11.

The isotropic optical properties (nx=ny) may be revealed seen and fixed and thus the noticeable light leakage may be restrained in a certain viewing angle of the display panel 100. Accordingly, the color of the light having a uniform brightness may be displayed on an entire image display area of the display panel 100.

According to embodiments, the viewing angle compensation film 150 may be configured to compensate the anisotropic optical properties of the liquid crystal capsule layer 120. Thus, it may be required to provide the viewing angle compensation film 150 having anisotropic optical properties that is opposite to anisotropic optical properties of the liquid crystal capsule layer 120 after acquiring information related to the anisotropic optical properties of the liquid crystal capsule layer 120, so as to apply the proper viewing angle compensation film 150 to the display apparatus 10.

The viewing angle compensation film 150 corresponding to the optical compensator may be implemented using a liquid crystal layer or a thin film coating as well as a film. When the optical compensator is implemented using other liquid crystal layer besides the liquid crystal capsule layer 120, the anisotropic optical properties of the liquid crystal capsule layer 120 may be compensated by controlling the electric field applied to the liquid crystal layer corresponding to the optical compensator. When the optical compensator is implemented using the thin film coating, a thin film may be coated on a transparent substrate to have anisotropic optical properties.

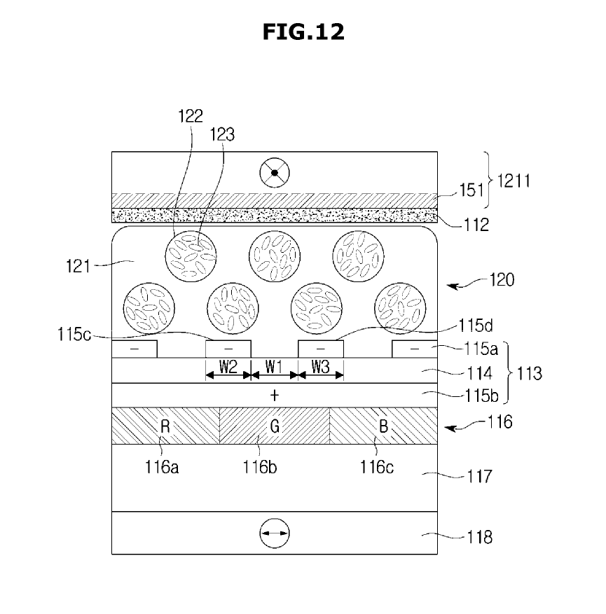

FIG. 12 is a view illustrating an operation of a viewing angle compensation film of a display apparatus in accordance with another embodiment. According to another embodiment, as illustrated in FIG. 12, a viewing angle compensation film 151 may be integrally formed with a first polarization unit 1211.

As illustrated in FIG. 12, a display panel 100 of a display apparatus 10 may include a first polarization unit 1211; a liquid crystal capsule layer protection unit 112; a liquid crystal capsule layer 120; an electrode layer 113; a color converter 116; a substrate 117 and a second polarization unit 118. The liquid crystal capsule layer protection unit 112 may correspond to a protection unit to protect the liquid crystal capsule layer 120.

The first polarization unit 1211 may be installed in the most front surface of the display panel 100 to polarize an incident light so as to emit the polarized light. One surface of the first polarization unit 1211 may be exposed to the outside via the opening 11c (refer to FIG. 3), and the other surface of the first polarization unit 1211 may make contact with the liquid crystal capsule layer protection unit 112 or the liquid crystal capsule layer 120. On the other surface of the first polarization unit 1211, the viewing angle compensation film 151 according to another embodiment may be integrally formed with the first polarization unit 1211. The viewing angle compensation film 151 may correspond to an optical compensator to reveal an isotropic refraction by compensating an anisotropic refraction of the liquid crystal capsule layer 120. For this, a manufacturing process of the first polarization unit 1211 may include forming the viewing angle compensation film 151. As mentioned description of FIG. 11, the viewing angle compensation film 151 may compensate the anisotropic optical properties (nx>ny) of the liquid crystal capsule layer 120 including the liquid crystal capsule 122 having the ellipsoid shape by using the anisotropic optical properties (nx<ny) that is opposite to the anisotropic optical properties (nx>ny) of the liquid crystal capsule layer 120, and thus the noticeable light leakage may be restrained in a certain viewing angle of the display panel 100. Accordingly, the color of the light having a uniform brightness may be displayed on an entire image display area of the display panel 100.

According to another embodiment, the viewing angle compensation film 151 may be configured to compensate the anisotropic optical properties of the liquid crystal capsule layer 120. Thus, it may be required to provide the first polarization unit 1211 integrally formed with the viewing angle compensation film 151 having anisotropic optical properties that is opposite to anisotropic optical properties of the liquid crystal capsule layer 120, after acquiring information related to the anisotropic optical properties of the liquid crystal capsule layer 120 so as to apply the first polarization unit 1211 to the display apparatus 10.

A light passing through the liquid crystal capsule layer protection unit 112 or a light penetrating the liquid crystal capsule layer 120 may be incident to the other surface of the first polarization unit 1211. The light delivered by passing through the liquid crystal capsule layer protection unit 112 or the light penetrating the liquid crystal capsule layer 120 may penetrate the second polarization unit 118 described later, and then polarized in a vertical direction or a horizontal direction. As mentioned above, the light polarized in the vertical direction or the horizontal direction via the second polarization unit 118 may be emitted to the outside by passing through the first polarization unit 1211 in a vibration direction or blocked by the first polarization unit 1211.

The first polarization unit 1211 may include a vertical polarization filter in which a polarization axis is the vertical direction and a horizontal polarization filter in which a polarization axis is the horizontal direction. The polarization axis of the first polarization unit 1211 may be different from the polarization axis of the second polarization unit 118. Particularly, the polarization axis of the first polarization unit 1211 may be perpendicular to the polarization axis of the second polarization unit 118. Therefore, when the second polarization unit 118 is the vertical polarization filter, the first polarization unit 1211 may be the horizontal polarization filter, and when the second polarization unit 118 is the horizontal polarization filter, the first polarization unit 1211 may be the vertical polarization filter.

One surface of the liquid crystal capsule layer 120 in the front direction may face the first polarization unit 1211. A plurality of liquid crystal capsules 122 may be provided in the liquid crystal capsule layer 120 and thus when a light is incident from a rear direction of the liquid crystal capsule layer 120, the liquid crystal capsule layer 120 may induce the incident light to be double refracted according to an electric field applied to the liquid crystal capsules 122.

According to one embodiment, the liquid crystal capsule layer 120 may include a polymer matrix 121 and a plurality of liquid crystal capsules 122 distributed in the polymer matrix 121.

“Polymer matrix” may represent an organization made of a polymer that is a molecule having a relatively very large molecular weight. The polymer matrix 121 may be implemented using a transparent material, e.g. a synthetic resin. In addition, the polymer matrix 121 may be formed of epoxy, polyurethane, methacrylate, dicyclopentadiene epoxy, polydicyclopentadiene or polyimide.

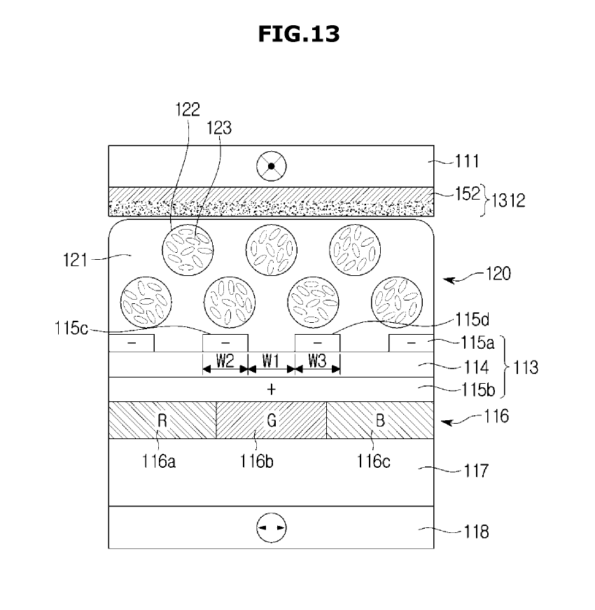

FIG. 13 is a view illustrating an operation of a viewing angle compensation film of a display apparatus in accordance with another embodiment. According to another embodiment, as illustrated in FIG. 13, a viewing angle compensation film 152 may be integrally formed with a liquid crystal capsule layer protection unit 1312.

As illustrated in FIG. 13, a display panel 100 of a display apparatus 10 may include a first polarization unit 111; a liquid crystal capsule layer protection unit 1312; a liquid crystal capsule layer 120; an electrode layer 113; a color converter 116; a substrate 117 and a second polarization unit 118.

The first polarization unit 111 may be installed in the most front surface of the display panel 100 to polarize an incident light so as to emit the polarized light. One surface of the first polarization unit 111 may be exposed to the outside via the opening 11c (refer to FIG. 3), and the other surface of the first polarization unit 111 may make contact with the liquid crystal capsule layer protection unit 1312 or the liquid crystal capsule layer 120. The first polarization unit 111 may be implemented in a film type.

One surface of the liquid crystal capsule layer protection unit 1312 may face the liquid crystal capsule layer 120 and the other surface of the liquid crystal capsule layer protection unit 1312, which is placed in an opposite side to the one surface thereof, may face the first polarization unit 111. On the other surface of the liquid crystal capsule layer protection unit 1312, the viewing angle compensation film 152 according to another embodiment may be integrally formed with the liquid crystal capsule layer protection unit 1312. The viewing angle compensation film 152 may correspond to an optical compensator to reveal an isotropic refraction by compensating an anisotropic refraction of the liquid crystal capsule layer 120. The liquid crystal capsule layer protection unit 1312 may correspond to a protector to protect the liquid crystal capsule layer 120. For this, a manufacturing process of the liquid crystal capsule layer protection unit 1312 may include forming the viewing angle compensation film 152. As mentioned description of FIG. 11, the viewing angle compensation film 152 may compensate the anisotropic optical properties (nx>ny) of the liquid crystal capsule layer 120 including the liquid crystal capsule 122 having the ellipsoid shape by using the anisotropic optical properties (nx<ny) that is opposite to the anisotropic optical properties (nx>ny) of the liquid crystal capsule layer 120, and thus the noticeable light leakage may be restrained from a certain viewing angle of the display panel 100. Accordingly, the color of the light having a uniform brightness may be displayed on an entire image display area of the display panel 100.

According to another embodiment, the viewing angle compensation film 152 may be configured to compensate the anisotropic optical properties of the liquid crystal capsule layer 120. Thus, it may be required to provide the liquid crystal capsule layer protection unit 1312 integrally formed with the viewing angle compensation film 152 having anisotropic optical properties that is opposite to anisotropic optical properties of the liquid crystal capsule layer 120, after acquiring information related to the anisotropic optical properties of the liquid crystal capsule layer 120, so as to apply the liquid crystal capsule layer protection unit 1312 to the display apparatus 10.

A light passing through the liquid crystal capsule layer protection unit 1312 or a light penetrating the liquid crystal capsule layer 120 may be incident to the other surface of the first polarization unit 111. The light delivered by passing through the liquid crystal capsule layer protection unit 1312 or the light penetrating the liquid crystal capsule layer 120 may penetrate the second polarization unit 118 described later, and then polarized in a vertical direction or a horizontal direction. As mentioned above, the light polarized in the vertical direction or the horizontal direction via the second polarization unit 118 may be emitted to the outside by passing through the first polarization unit 111 in a vibration direction or blocked by the first polarization unit 111.

The first polarization unit 111 may include a vertical polarization filter in which a polarization axis is the vertical direction and a horizontal polarization filter in which a polarization axis is the horizontal direction. The polarization axis of the first polarization unit 111 may be different from the polarization axis of the second polarization unit 118. Particularly, the polarization axis of the first polarization unit 111 may be perpendicular to the polarization axis of the second polarization unit 118. Therefore, when the second polarization unit 118 is the vertical polarization filter, the first polarization unit 111 may be the horizontal polarization filter, and when the second polarization unit 118 is the horizontal polarization filter, the first polarization unit 111 may be the vertical polarization filter.

One surface of the liquid crystal capsule layer 120 in the front direction may face the first polarization unit 111. A plurality of liquid crystal capsules 122 may be provided in the liquid crystal capsule layer 120 and thus when a light is incident from a rear direction of the liquid crystal capsule layer 120, the liquid crystal capsule layer 120 may induce the incident light to be double refracted according to an electric field applied to the liquid crystal capsules 122.

According to one embodiment, the liquid crystal capsule layer 120 may include a polymer matrix 121 and a plurality of liquid crystal capsules 122 distributed in the polymer matrix 121.

“Polymer matrix” may represent an organization made of a polymer that is a molecule having a relatively very large molecular weight. The Polymer matrix 121 may be implemented using a transparent material, e. g, a synthetic resin. In addition, the polymer matrix 121 may be formed of epoxy, polyurethane, methacrylate, dicyclopentadiene epoxy, polydicyclopentadiene or polyimide.

As is apparent from the above description, according to the proposed display panel and display apparatus having the same, it may be possible to improve a viewing angle of the display apparatus by compensating the variation of the optical proprieties of the liquid crystal capsule layer caused by the deformation of the plurality of the liquid crystal capsules distributed on the liquid crystal capsule layer.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A display apparatus, comprising:
a liquid crystal capsule layer on which a plurality of liquid crystal capsules are distributed; and
an optical compensator configured to compensate an anisotropic refraction of the liquid crystal capsule layer.

2. The display apparatus of claim 1, wherein
the anisotropic refraction of the liquid crystal capsule layer is caused by a deformation of the plurality of liquid crystal capsules.

3. The display apparatus of claim 2, wherein
the deformation of the plurality of liquid crystal capsules is into an ellipsoid.

4. The display apparatus of claim 1, wherein
the optical compensator is configured to have anisotropic optical properties to compensate the liquid crystal capsule layer to produce a refractive index of the liquid crystal capsule layer in a horizontal direction identical to the refractive index of the liquid crystal capsule layer in a vertical direction.

5. The display apparatus of claim 4, wherein
when the refractive index in the horizontal direction is larger than the refractive index in the vertical direction with respect to an area of the liquid crystal capsule layer, the refractive index in the horizontal direction is smaller than the refractive index in a vertical direction with respect to the area of the optical compensator, and
when the refractive index in the horizontal direction is smaller than the refractive index in the vertical direction with respect to the area of the liquid crystal capsule layer, the refractive index in the horizontal direction is larger than a refractive index in the vertical direction with respect to the area of the optical compensator

6. The display apparatus of claim 1, further comprising:
a first polarization unit and a protection unit disposed on a front side of the liquid crystal capsule layer, wherein the optical compensator is provided as a separate object between the first polarization unit and the protection unit.

7. The display apparatus of claim 1, further comprising:
a first polarization unit and a protection unit disposed on a front side of the liquid crystal capsule layer, where the optical compensator is integrally formed with one of the first polarization unit and the protection unit.

8. The display apparatus of claim 1, wherein
the optical compensator is provided in a type of a film comprising one of a liquid crystal layer and a thin film.

9. A display apparatus, comprising:
a liquid crystal capsule layer on which a plurality of liquid crystal capsules are distributed;
a first polarization unit provided on a front side of the liquid crystal capsule layer;
an optical compensator configured to compensate an anisotropic refraction caused by a deformation of the plurality of liquid crystal capsules in the liquid crystal capsule layer;
a protection unit provided on the front side of the liquid crystal capsule layer to protect the liquid crystal capsule layer; and
a second polarization unit provided on a rear side of the liquid crystal capsule layer.

10. The display apparatus of claim 9, wherein
the deformation of the plurality of liquid crystal capsules is into an ellipsoid.

11. The display apparatus of claim 9, wherein
the optical compensator is configured to have anisotropic optical properties to compensate the liquid crystal capsule layer to produce a refractive index of the liquid crystal capsule layer in the horizontal direction identical to a refractive index of the liquid crystal capsule layer in the vertical direction.

12. The display apparatus of claim 11, wherein
when the refractive index in the horizontal direction is larger than the refractive index in the vertical direction with respect to an area of the liquid crystal capsule layer, the refractive index in the horizontal direction is smaller than a refractive index in a vertical direction with respect to the area of the optical compensator, and
when the refractive index in the horizontal direction is smaller than the refractive index in the vertical direction with respect to the area of the liquid crystal capsule layer, the refractive index in the horizontal direction is larger than a refractive index in the vertical direction with respect to the area of the optical compensator

13. The display apparatus of claim 9, wherein
the optical compensator is provided as a separate object between the first polarization unit and the protection unit.

14. The display apparatus of claim 9, further comprising:
a first polarization unit and a protection unit disposed on a front side of the liquid crystal capsule layer, wherein the optical compensator is integrally formed with one of the first polarization unit and the protection unit.

15. The display apparatus of claim 9, wherein
the optical compensator is provided in a type of a film comprising one of a liquid crystal layer and a thin film.

16. A display panel, comprising:
a liquid crystal capsule layer on which a plurality of liquid crystal capsules are distributed;
a first polarization unit provided on a front side of the liquid crystal capsule layer;
an optical compensator configured to compensate an anisotropic refraction caused by a deformation of the plurality of liquid crystal capsules in the liquid crystal capsule layer;
a protection unit provided on a front side of the liquid crystal capsule layer; and
a second polarization unit provided ion a rear side of the liquid crystal capsule layer.
